(19) United States
(12) Patent Application Publication
(10) Pub. No.: US 2014/0251650 A1
(43) Pub. Date: Sep. 11, 2014

(54) POWER TOOL AND POWER TOOL ACCESSORY MEMBER

(71) Applicant: MAKITA CORPORATION, Anjo-shi (JP)

(72) Inventor: Tomoyuki KONDO, Anjo-shi (JP)

(73) Assignee: MAKITA CORPORATION, Anjo-shi (JP)

(21) Appl. No.: 13/793,306

(22) Filed: Mar. 11, 2013

(51) Int. Cl. B25F 5/02

(52) U.S. Cl. CPC B25F 5/02
USPC 173/171

(57) ABSTRACT

A power tool includes a motor unit, a main body portion, a grip portion and a female thread part. The main body portion accommodates the motor unit therein. The grip portion extends from the main body portion. The female thread part is retained to the main body portion. The female thread part includes a female thread configured and arranged to engage with a male thread of a male thread part of a power tool accessory member.

### BACKGROUND

1. Field of the Invention

The present invention generally relates to a power tool. More specifically, the present invention relates to a power tool with a power tool accessory member removably coupled to the power tool.

2. Background Information

Conventional power tools are often used with accessory members such as a hook member, a lighting unit, an auxiliary handle member, and the like. For example, Japanese Utility Model Patent Application Publication No. H5-4168 discloses a hook attachment structure for a power tool. In this publication, the hook member formed by bending a plate shaped element is fixed to the power tool by a bolt that threadedly engages a nut disposed within a housing or a handle cover in a grip portion.

### SUMMARY

In the conventional hook attachment structure for the power tool as discussed above, the nut is provided only for the purpose of attaching the hook member. Therefore, when the hook member is not attached to the power tool, the nut is also not used, and thus, the space occupied by the nut is wasted.

In view of the state of the known technology, a power tool according to one aspect includes a motor unit, a main body portion, a grip portion and a female thread part. The main body portion accommodates the motor unit therein. The grip portion extends from the main body portion. The female thread part is retained to the main body portion. The female thread part includes a female thread configured and arranged to engage with a male thread of a male thread part of a power tool accessory member.

Other objects, features, aspects and advantages of the disclosed power tool with the power tool accessory member will become apparent to those skilled in the art from the following detailed description, which, taken in conjunction with the annexed drawings, discloses preferred embodiments of the power tool with the power tool accessory member.

### BRIEF DESCRIPTION OF THE DRAWINGS

Referring now to the attached drawings which form a part of this original disclosure:

FIG. 1 is a perspective view of a power tool with a power tool accessory member according to a first embodiment;

FIG. 2 is a vertical cross sectional view of the power tool with the power tool accessory member illustrated in FIG. 1;

FIG. 3 is a partial cross sectional view of the power tool with the power tool accessory member illustrated in FIGS. 1 and 2 as taken along a section line 3-3 in FIG. 2;

FIG. 4 is a cross sectional view of the power tool with the power tool accessory member as illustrated in FIGS. 1 to 3 as take along a section line 4-4 in FIG. 3;

FIG. 5 is an exploded partial cross sectional view of the power tool and the power tool accessory member illustrated in FIGS. 1 to 4;

FIG. 6 is a perspective view of a power tool with a power tool accessory member according to a second embodiment;

FIG. 7 is a vertical cross sectional view of the power tool with the power tool accessory member illustrated in FIG. 6;

FIG. 8 is a partial cross sectional view of the power tool with the power tool accessory member illustrated in FIGS. 6 and 7 as taken along a section line 8-8 in FIG. 7;

FIG. 9 is a cross sectional view of the power tool with the power tool accessory member as illustrated in FIGS. 6 to 8 as take along a section line 9-9 in FIG. 8;

FIG. 10 is an exploded partial cross sectional view of the power tool and the power tool accessory member illustrated in FIGS. 6 to 9;

FIG. 11 is a perspective view of a power tool with a power tool accessory member according to a third embodiment;

FIG. 12 is a vertical cross sectional view of the power tool with the power tool accessory member illustrated in FIG. 11;

FIG. 13 is a partial cross sectional view of the power tool with the power tool accessory member illustrated in FIGS. 11 and 12 as taken along a section line 13-13 in FIG. 12;

FIG. 14 is a cross sectional view of the power tool with the power tool accessory member as illustrated in FIGS. 11 to 13 as take along a section line 14-14 in FIG. 13; and

FIG. 15 is an exploded partial cross sectional view of the power tool and the power tool accessory member illustrated in FIGS. 11 to 14.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

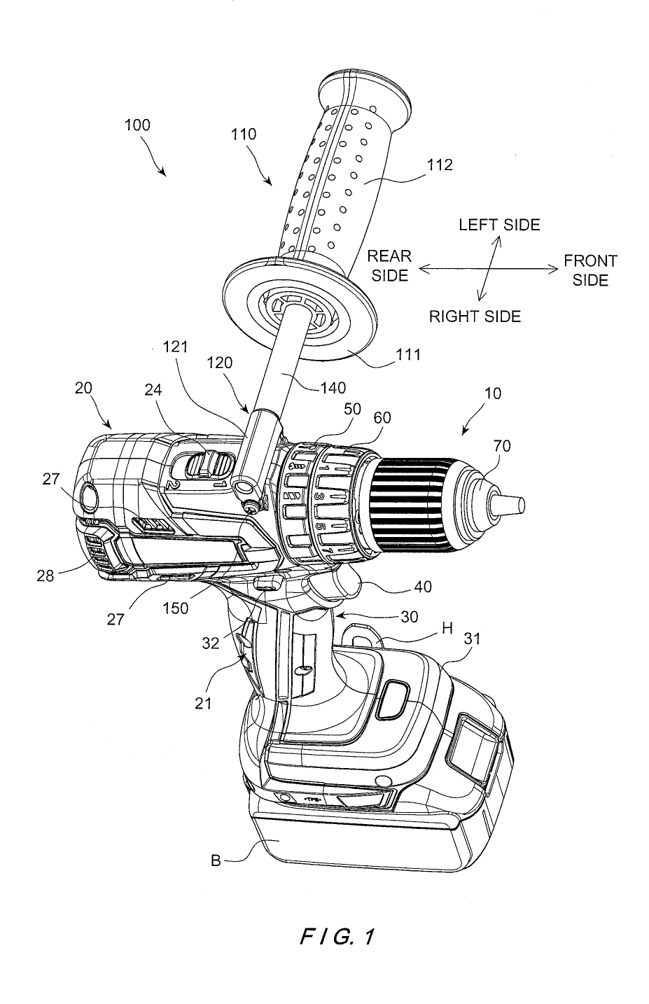

Referring initially to FIGS. 1 to 5, a power tool 10 with an auxiliary handle member 100 as one example of a power tool accessory member is illustrated in accordance with a first embodiment. The auxiliary handle member 100 is selectively coupled with the power tool 10 to provide a secondary grip position for a user to support the power tool 10 with both hands during operation.

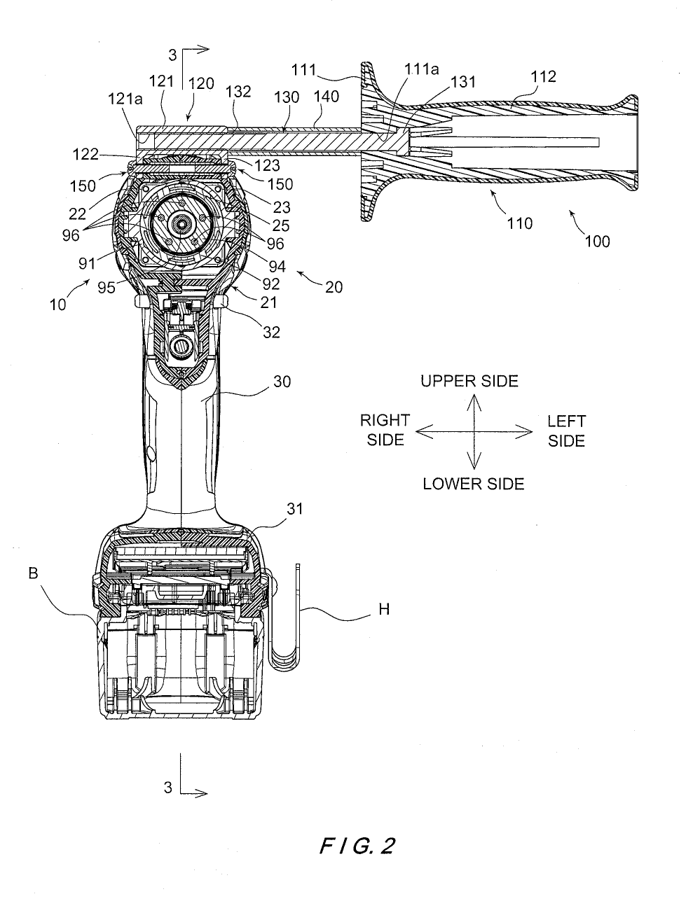

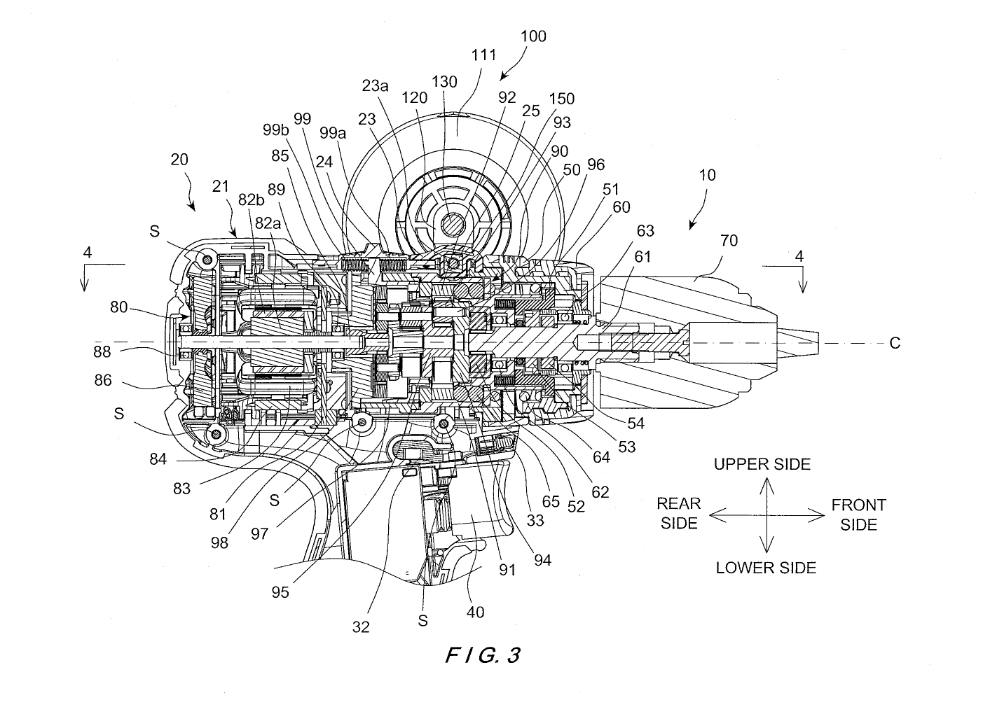

In the first embodiment illustrated in FIGS. 1 to 5, the power tool 10 is a cordless hammer driver drill. As shown in FIGS. 1 and 2, the power tool 10 has a generally pistol-like overall shape formed by a generally tubular main body portion 20 and a grip portion 30. The grip portion 30 extends downwardly from the main body portion 20 between a front end and a rear end of the main body portion 20. An outer surface of at least a part of the main body portion 20 and the grip portion 30 are integrally formed to define an outer housing cover 21. The outer housing cover 21 is preferably made of resin material. More specifically, the outer housing cover 21 includes a right housing cover 22 (one example of a second side body section) and a left housing cover 23 (one example of a first side body section). The right housing cover 22 and the left housing cover 23 are fixed together at a plurality of prescribed fixing positions by a plurality of screws S and a pair of screws 150 (see, FIG. 3) as explained in more detail below. Moreover, as shown in FIG. 1, the main body portion 20 includes a speed change lever 24 for changing a rotational speed of the power tool 10. The outer housing cover 21 of the main body portion 20 further includes a plurality of openings defining front intake ports 27 and exhaust ports 28. Cooling air enters into the main body portion 20 through the front intake ports 27, and the cooling air is discharged from the exhaust ports 28, thereby forming cooling air passages that flow through inside of the main body portion 20 for cooling internal components accommodated in the main body portion 20.

As shown in FIGS. 1 and 3, a trigger-type switch lever 40 is provided at an upper end region of the grip portion 30 for driving the power tool 10. A lower end of the grip portion 30 includes a battery connecting portion 31, which is coupled to a rechargeable battery B. The battery B serves as a power source for the power tool 10. Preferably, the rechargeable battery B is removably attached to the lower end of the grip portion 30. The rechargeable battery B is a conventional battery such as a lithium-ion battery, a nickel cadmium battery, etc. As shown in FIG. 1, a rotational direction change lever 32 is provided in a region where the grip portion 30 meets the main body portion 20 for switching a rotational direction of the power tool 10. As shown in FIG. 3, a light unit 33 is provided in a front end of the region where the grip portion 30 meets the main body portion 20 for illuminating the work area. Also, as shown in FIG. 2, a hook member H is removably attached to one side of the lower end portion of the grip portion 30 for temporarily hanging the power tool 10.

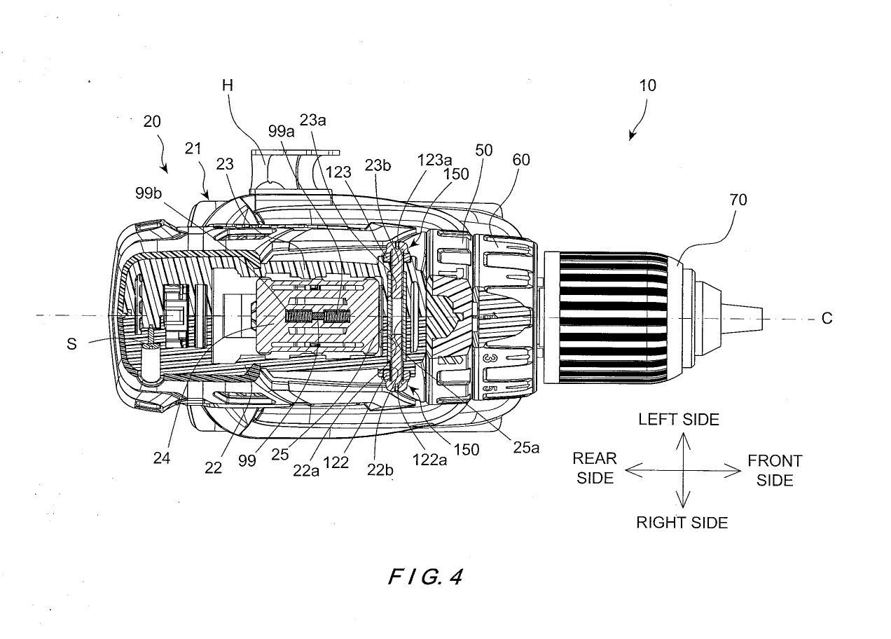

As shown in FIGS. 1 and 4, a mode change ring 50 is disposed on a front side of the main body portion 20 so as to be rotatable about a center axis C of the main body portion 20 to change an operation mode (action mode) of the power tool 10. A tubular change ring 60 is disposed on a front side of the mode change ring 50 so as to be independently rotatable about the center axis C of the main body portion 20 to adjust a rotation torque of the power tool 10. As shown in FIG. 3, the mode change-change ring 50 and the tubular change ring 60 are operatively coupled to a spindle 61. A power tool chuck 70 is attached around a front end part of the spindle 61 for holding a tool piece (not shown). The tool piece includes, for example, a drill bit, a screwdriver bit, etc.

As shown in FIG. 3, a motor unit 80 is disposed in a rear portion of the main body portion 20. In the power tool 10 of this example, the motor unit 80 constitutes a conventional brushless motor, which includes a rotor having a rotor core 82a and a permanent magnet 82b, and a stator having stator coils 83 and a stator core 84. The motor unit 80 further includes conventional components such as a circuit board 81, an output shaft 85, a fan 86, and a rear bearing 88.

As shown in FIG. 3, a gear assembly 90 is disposed in front of the motor unit 80 inside the main body portion 20. The spindle 61 is operatively coupled to the gear assembly 90 so that the gear assembly 90 transmits rotation of the output shaft 85 of the motor unit 80 to the power tool chuck 70 via the spindle 61, when the switch lever 40 is operated. More specifically, the gear assembly 90 includes a front gear case 91, a plurality of gears including an internal gear 92, a plurality of planetary gears 93, a carrier 94, a pinion 95, a plurality of pins 96, a rear gear case 97, and a gear box lid 98. The spindle 61 is rotatably supported by a pair of bearings 62 and 63. A front bearing 89 is coupled to the gear box lid 98 for rotatably supporting the output shaft 85 of the motor unit 80. The speed change lever 24 is operatively coupled to the internal gear 92 via a connecting ring 99 so that a rotational speed of the power tool 10 (i.e., a rotational speed of the spindle 61) is changed by operating the speed change lever 24. A pair of springs 99a and 99b are coupled to the connecting ring 99 for selectively biasing the speed change lever 24 in the longitudinal direction of the main body portion 20. In this example, a conventional torque adjustment mechanism (clutch mechanism) including a coli spring 64 and a plurality of balls 65 is provided for preventing overtightening beyond desired torque. Also, the power tool 10 is provided with a conventional vibration mechanism including a vibration switch cam 51, a lock cam 52, a first cam 53, and a second cam 54, etc. The vibration mechanism is operatively coupled to the torque adjustment mechanism. Therefore, by rotating the mode change ring 50, a mode change operation is performed for selection among a percussion drill mode in which the spindle 61 is caused to make a vibration motion while making a rotatory motion, a drill mode in which the spindle 61 is caused to make the rotatory motion only, and a clutch mode (driver mode) in which a transmission of torque to the spindle 61 is interrupted at overload beyond the predetermined threshold.

Since the components of the power tool 10, such as the mode change ring 50, the tubular change ring 60, the power tool chuck 70, the motor unit 80 and the gear assembly 90, the components constituting the clutch mechanism and the components constituting the vibration mechanism, are conventional components that are well known in the art, the structure of these components will not be discussed or illustrated in detail herein. Rather, it will be apparent to those skilled in the art from this disclosure that the components of the power tool 10 can have any type of suitable structure.

As shown in FIGS. 2 to 5, a nut member 25 (one example of a female thread part) having an elongated tubular body is disposed in an upper portion of the main body portion 20 of the power tool 10. More specifically, the nut member 25 is disposed at one of the prescribed fixing positions in the main body portion 20 at which the right housing cover 22 and the left housing cover 23 are fixed together. As shown in FIG. 3, these prescribed fixing positions are spaced apart from each other. The nut member 25 is arranged so that a longitudinal axis of the nut member 25 extends in a transverse direction perpendicular to the longitudinal center axis C of the main body portion 20. The nut member 25 has a generally polygonal outer contour in a cross section taken along a plane perpendicular to the longitudinal axis of the nut member 25. More specifically, in this embodiment, the nut member 25 has a generally rectangular outer contour as shown in FIG. 3. An inner circumference surface of the nut member 25 includes a female thread section 25a provided with a female thread.

The nut member 25 is non-movably coupled to the main body portion 20 between the right housing cover 22 and the left housing cover 23 of the outer housing cover 21. More specifically, the nut member 25 is non-movably disposed within a through hole 21a that extends in the transverse direction perpendicular to the longitudinal center axis C of the main body portion 20. The right housing cover 22 defines a part of the through hole 21a formed by a larger diameter portion 22a and a smaller diameter portion 22b disposed outwardly of the larger diameter portion 22a. Likewise, the left housing cover 23 defines a part of the through hole 21a formed by a larger diameter portion 23a and a smaller diameter portion 23b disposed outwardly of the larger diameter portion 23a.

The larger diameter portion 22a of the right housing cover 22 and the smaller diameter portion 23a of the left housing cover 23 define a generally polygonal inner contour in a cross section taken along a plane perpendicular to the longitudinal axis of the through hole 21a. More specifically, in this embodiment, the larger diameter portion 22a of the right housing cover 22 and the smaller diameter portion 23a of the left housing cover 23 define a generally rectangular inner contour as shown in FIG. 3. The inner contour of the larger diameter portion 22a of the right housing cover 22 and the larger diameter portion 23a of the left housing cover 23 matches the generally rectangular outer contour of the nut member 25. Therefore, the nut member 25 is non-rotatably fitted in the larger diameter portion 22a of the right housing cover 22 and the larger diameter portion 23a of the left housing cover 23 as shown in FIG. 3.

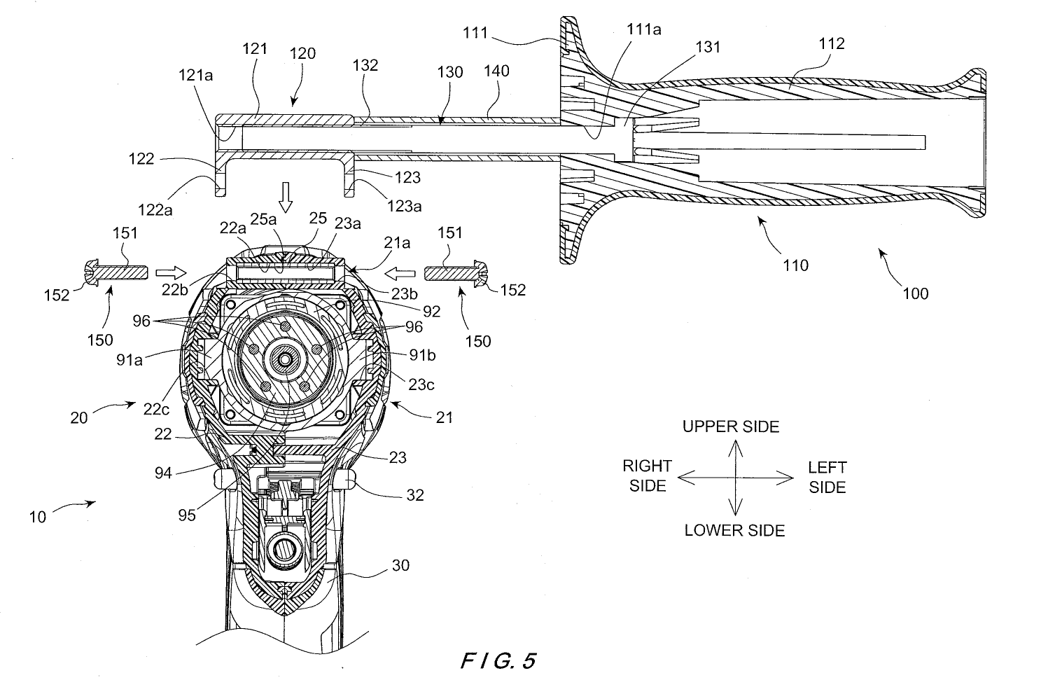

A maximum inner diameter of the smaller diameter portion 22b of the right housing cover 22 and a maximum inner diameter of the smaller diameter portion 23b of the left housing cover 23 are smaller than a minimum outer diameter of the nut member 25 as shown in FIGS. 4 and 5. Therefore, movement of the nut member 25 with respect to the outer housing cover 21 in the transverse direction is restricted by the smaller diameter portion 22b of the right housing cover 22 and the smaller diameter portion 23b of the left housing cover 23. On the other hand, the maximum inner diameter of the smaller diameter portion 22b of the right housing cover 22 and the maximum inner diameter of the smaller diameter portion 23b of the left housing cover 23 are larger than a maximum inner diameter of the nut member 25 (i.e., the major diameter of the female thread in the female thread section 25a). Therefore, the smaller diameter portion 22b of the right housing cover 22 and the smaller diameter portion 23b of the left housing cover 23 define a pair of access openings respectively formed on each side of the outer surface of the main body portion 20 through which the female thread in the female thread section 25a is accessible from an outside of the main body portion 20.

As shown in FIG. 5, the right housing cover 22 includes a concave portion 22c to which a right side convex portion 91a of the front gear case 91 is inserted. Likewise, the left housing cover 23 includes a concave portion 23c to which a left side convex portion 91b of the front gear case 91 is inserted. Therefore, the front gear case 91 is fixedly secured between the right housing cover 22 and the left housing cover 23, and rotation of the front gear case 91 with respect to the right hosing cover 22 and the left housing cover 23 is prevented.

Referring now to FIGS. 1, 2 and 5, the structure of the auxiliary handle member 100 will be described as one example of the power tool accessory member. The auxiliary handle member 100 is an auxiliary tool that is removably coupled to the power tool 10 to provide a secondary grip portion for a user to support the power tool 10 with both hands during operation. The auxiliary handle member 100 basically includes an auxiliary grip portion 110, a bracket member 120, a threaded rod member 130, and a sleeve member 140. When the power tool 10 is used with the auxiliary handle member 100, the bracket member 120 of the auxiliary handle member 100 is fixedly coupled to the main body portion 20 of the power tool 10 by the screws 150 as shown in FIGS. 1 to 4.

The auxiliary grip portion 110 of the auxiliary handle member 100 includes a flange section 111 and a body section 112. As shown in FIGS. 2 and 5, a through-hole 111a is formed in the flange section 111 for passing the threaded rod member 130 therein. A head part 131 of threaded rod member 130 is non-rotatably fixed to an inner end part of the through-hole 111a. An outer surface of the body section 112 is preferably made of rubber or plastic material, and may be provided with an anti-slip surface structure or coating to prevent the user's hand from slipping during operation.

The bracket member 120 includes a tubular part 121 and a pair of attachment parts 122 and 123 protruding from axial end portions of the tubular part 121. An inner circumferential surface of the tubular part 121 of the bracket member 120 includes a female thread section 121a including a female thread. The threaded rod member 130 includes a male thread section 132 that threadedly engage the female thread section 121a of the tubular part 121 of the bracket member 120. The attachment parts 122 and 123 of the bracket member 120 include apertures 122a and 123a, respectively, through which a shaft 151 of a corresponding one of the screws 150 is inserted. A diameter of each of the apertures 122a and 123a is larger than the major diameter of the shaft 151 of the screw 150, and smaller than a diameter of a head 152 of the screw 150 as shown in FIGS. 2 and 4.

The sleeve member 140 covers an outer circumference of the threaded rod member 130 between the auxiliary grip portion 110 and the bracket member 120.

When the auxiliary handle member 100 is coupled to the main body portion 20 of the power tool 10, the auxiliary handle member 100 is positioned with respect to the main body portion 20 of the power tool 10 so that the apertures 122a and 123a of the attachment parts 122 and 123 of the bracket member 120 are coaxially aligned with the through hole 21a of the outer housing cover 21. More specifically, as shown in FIGS. 2 and 4, the aperture 122a of the attachment part 122 is coaxially aligned with the smaller diameter portion 22b of the right housing cover 22 and the aperture 123a of the attachment part 123 is coaxially aligned with the smaller diameter portion 23b of the left housing cover 23. Then, the shafts 151 of the screws 150 are inserted from the apertures 122a and 123a of the attachment parts 122 and 123 of the bracket member 120, and pass through the smaller diameter portions 22b and 23b of the right housing cover 22 and the left housing cover 23, respectively. The screws 150 are tightened so that the male threads formed on the shafts 151 of the screws 150 threadedly engage with the female thread in the female thread section 25a of the nut member 25 from each transverse side of the nut member 25 as shown in FIGS. 2 and 4. Accordingly, the bracket member 120 of the auxiliary handle member 100 is fixedly coupled to the main body portion 20 of the power tool 10 by the nut member 25 and the screws 150 as shown in FIGS. 1 to 4. Therefore, the screws 150 constitute a male thread part of the auxiliary handle member 100 when the auxiliary handle member 100 is attached to the power tool 10. At the same time, the nut member 25 and the screws 150 also serve as a fixing member that fixedly couples the right housing cover 22 and the left housing cover 23 at one of the prescribed fixing positions.

On the other hand, when power tool 10 is used without the auxiliary handle member 100 being attached thereto, the screws 150 are used to fixedly couple the right housing cover 22 and the left housing cover 23. In such a case, the shafts 151 of the screws 150 are directly inserted through the smaller diameter portions 22b and 23b of the right housing cover 22 and the left housing cover 23, respectively. The screws 150 are tightened so that the male threads formed on the shafts 151 of each of the screws 150 threadedly engage with the female threads in the female thread section 25a of the nut member 25 from each transverse side of the nut member 25. Therefore, the right housing cover 22 and the left housing cover 23 are fixed together by the nut member 25 and the screws 150 at one of the prescribed fixing positions while the screws S are used to fixedly couple the right housing cover 22 and the left housing cover 23 together at the rest of the prescribed fixing positions.

Accordingly, with the structure of the power tool 10 according to the first embodiment, the screws 150 and the nut member 25 are used for fixing the bracket member 120 of the auxiliary handle member 100 to the main body portion 20 as they simultaneously fix the right housing cover 22 and the left housing cover 23 together when the auxiliary handle member 100 is used with the power tool 10. On the other hand, when the auxiliary handle member 100 is not used with the power tool 10, the screws 150 and the nut member 25 are used for fixing the right housing cover 22 and the left housing cover 23 together. Moreover, the nut member 25 is disposed at one of the prescribed fixing positions at which the right housing cover 22 and the left housing cover 23 are fixed together. Therefore, with the power tool 10 according to the first embodiment, it is not necessary to provide an extra space in the main body portion 20 for placing a nut member that is used only when the power tool accessory member is attached to the power tool 10. Accordingly, with the structure of the power tool 10 in the first embodiment, a space inside the main body portion 20 can be efficiently used, thereby preventing the overall size of the main body portion 20 of the power tool 10 from increasing.

### Second Embodiment

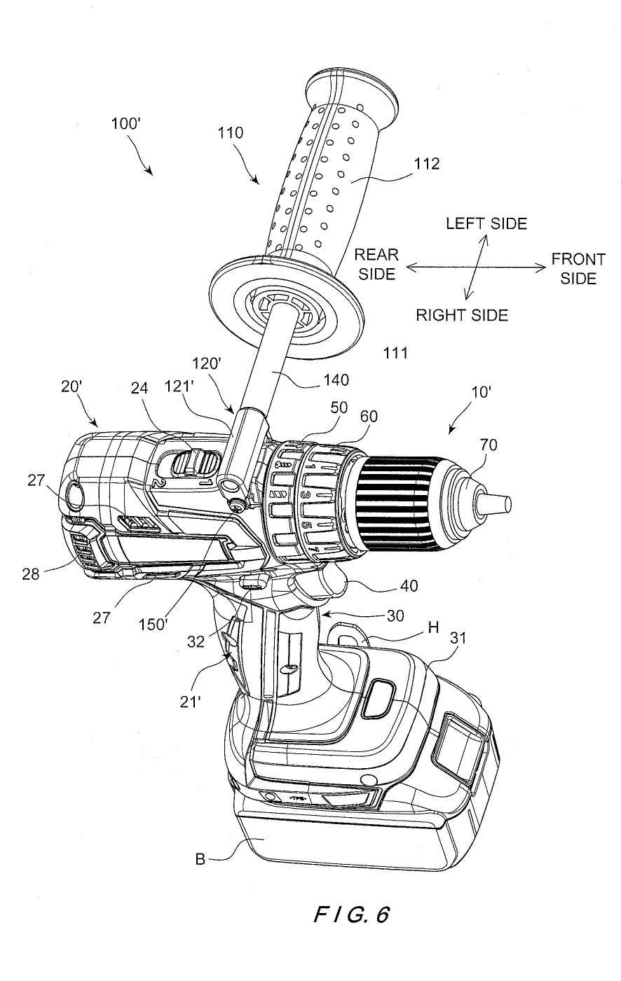

Referring now to FIGS. 6 to 10, a power tool 10′ with an auxiliary handle member 100′ in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with a single prime (′).

The second embodiment differs from the first embodiment in that a single screw 150′ is used to fixedly couple a bracket member 120′ of the auxiliary handle member 100′ to a main body portion 20′ of the power tool 10′.

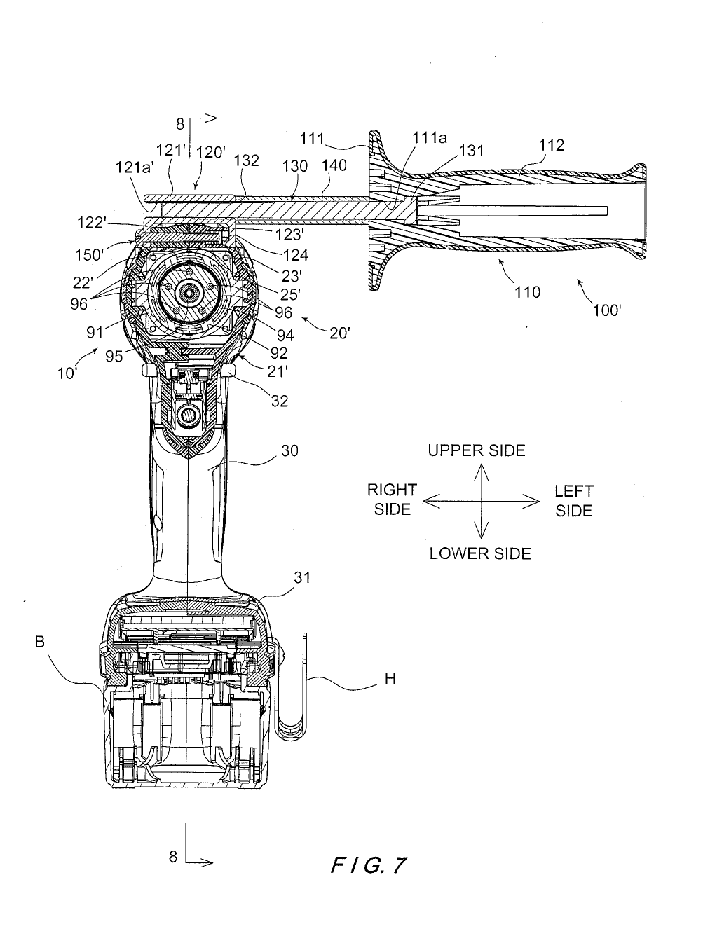

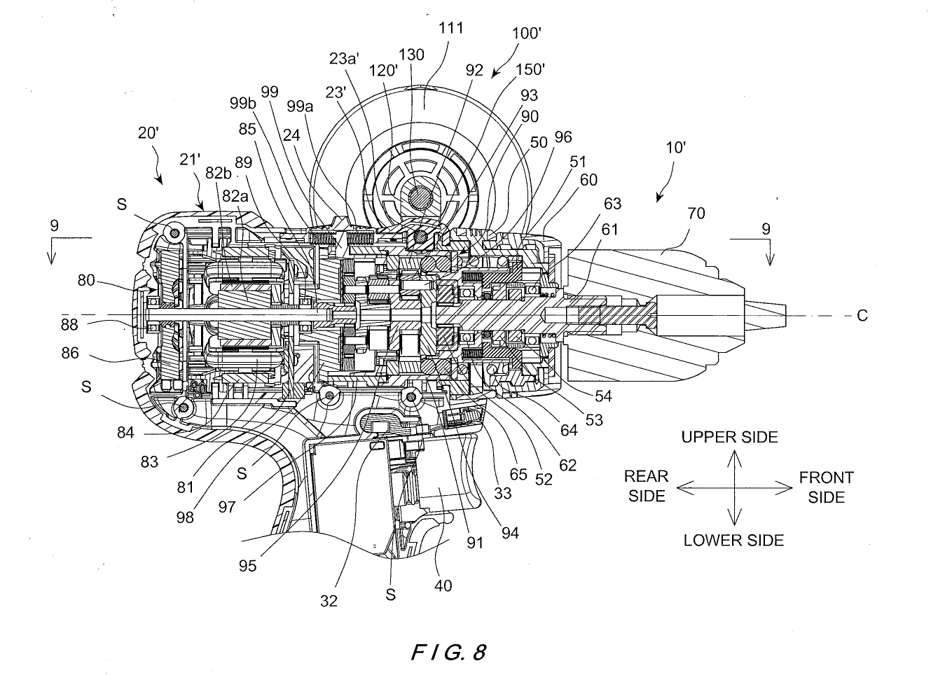

As shown in FIGS. 7, 9 and 10, a nut member 25′ (one example of a female thread part) having a tubular body is disposed in an upper portion of the main body portion 20′ of the power tool 10′. More specifically, similarly to the first embodiment, the nut member 25′ is disposed at one of the prescribed fixing positions in the main body portion 20′ at which a right housing cover 22′ and a left housing cover 23′ are fixed together by the screws S and the screw 150′. As shown in FIG. 8, these prescribed fixing positions are spaced apart from each other. The nut member 25′ is arranged so that a center axis of the nut member 25′ extends in a transverse direction perpendicular to the longitudinal center axis C of the main body portion 20′. The nut member 25′ has a generally circular outer contour in a cross section taken along a plane perpendicular to the center axis of the nut member 25′ as shown in FIG. 8. An inner circumference surface of the nut member 25′ includes a female thread section 25a′ provided with a female thread.

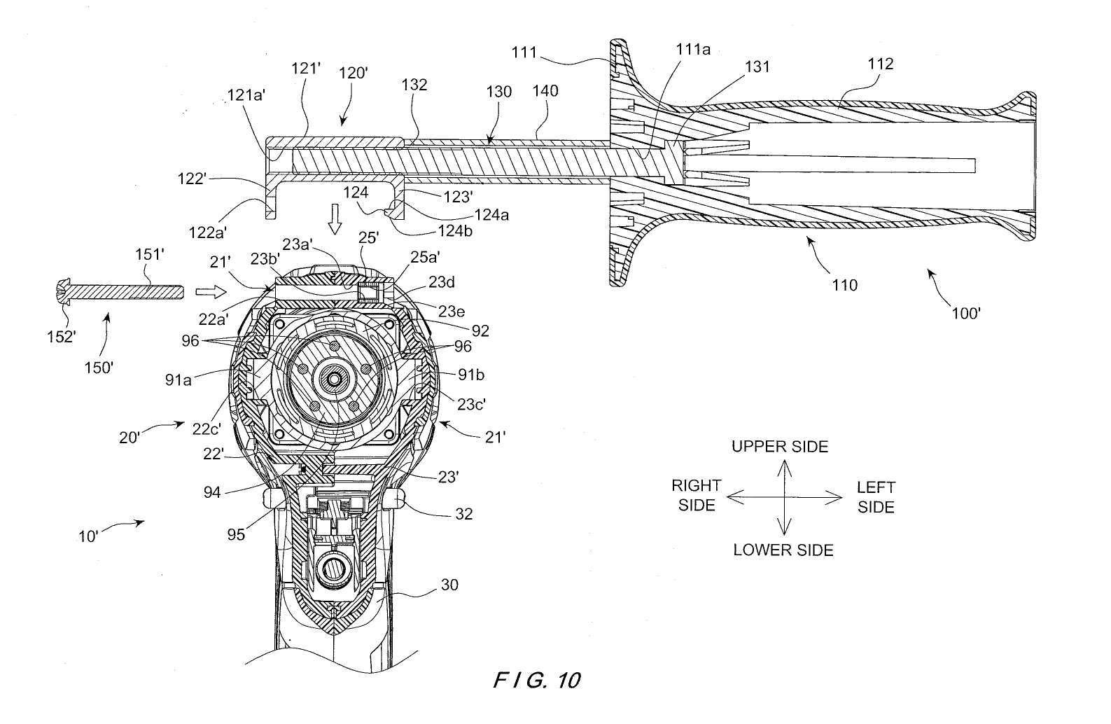

In the second embodiment, the nut member 25′ is non-movably coupled to the left housing cover 23′ of the outer housing cover 21′. The nut member 25′ is non-movably disposed within a through hole 21a′ that extends in the transverse direction perpendicular to the longitudinal center axis C of the main body portion 20′. The right housing cover 22′ defines a part of the through hole 21a′ formed by a through hole 22a′, and the left housing cover 23′ defines a part of the through hole 21a′ formed by a through hole 23a′ and a counterbore 23b′ disposed outwardly of the through hole 23a′. The left housing cover 23′ further includes an concave portion including an upper flat surface 23d and a lower tapered surface 23e that are disposed outwardly of the counterbore 23b′ as shown in FIG. 10. The nut member 24′ is press-fitted in the counterbore 23b′ of the left housing cover 23′ from an outside of the left housing cover 23′ so as not to move with respect to the left housing cover 23′.

A maximum inner diameter of the through hole 22a′ of the right housing cover 22′ and a maximum inner diameter of the through hole 23a′ of the left housing cover 23′ are larger than a maximum inner diameter of the nut member 25′ (i.e., the major diameter of the female thread in the female thread section 25a′). Therefore, the through hole 22a′ of the right housing cover 22′ defines an access opening formed on the rights side of the outer surface of the main body portion 20′ through which the female thread in the female thread section 25a′ is accessible from an outside of the main body portion 20′.

Similarly to the first embodiment, as shown in FIG. 10, the right housing cover 22′ includes a concave portion 22c′ to which the right side convex portion 91a of the front gear case 91 is inserted. Likewise, the left housing cover 23′ includes a concave portion 23c′ to which the left side convex portion 91b of the front gear case 91 is inserted. Therefore, the front gear case 91 is fixedly secured between the right housing cover 22′ and the left housing cover 23′, and rotation of the front gear case 91 with respect to the right hosing cover 22′ and the left housing cover 23′ is prevented.

Referring now to FIGS. 6, 7 and 10, the structure of the auxiliary handle member 100′ will be described as one example of the power tool accessory member. In the second embodiment, the auxiliary handle member 100′ basically includes the auxiliary grip portion 110, the bracket member 120′, the threaded rod member 130, and the sleeve member 140. When the power tool 10′ is used with the auxiliary handle member 100′, the bracket member 120′ of the auxiliary handle member 100′ is fixedly coupled to the main body portion 20′ of the power tool 10′ by the screw 150′ as shown in FIGS. 6 to 9.

The bracket member 120′ includes a tubular part 121′ and attachment parts 122′ and 123′ protruding from axial end portions of the tubular part 121′. An inner circumferential surface of the tubular part 121′ of the bracket member 120′ includes a female thread section 121a′ including a female thread. The threaded rod member 130 includes the male thread section 132 that threadedly engage the female thread section 121a′ of the tubular part 121′ of the bracket member 120′. In the second embodiment, the attachment part 122′ of the bracket member 120′ includes an aperture 122a′ through which a shaft 151′ of the screw 150′ is inserted. A diameter of each of the aperture 122a′ is larger than the major diameter of the shaft 151′ of the screw 150′, and smaller than a diameter of a head 152′ of the screw 150′ as shown in FIGS. 2 and 4. The attachment part 123′ of the bracket member 120′ in the second embodiment includes a tapered projection 124 that protrudes inwardly from a distal end of the attachment part 123′. The tapered projection 124 includes an upper flat surface 124a and a lower tapered surface 124b that abut respectively against the upper flat surface 23d and the lower tapered surface 23e of the left housing cover 23′ when the bracket member 120′ of the auxiliary handle member 100′ is attached to the main body portion 20′ of the power tool 10′ as shown in FIG. 7. The engagement between the tapered projection 124 and the left housing cover 23′ restricts a vertical movement of the bracket member 120′ of the auxiliary handle member 100′ with respect to the main body portion 20′ of the power tool 10′.

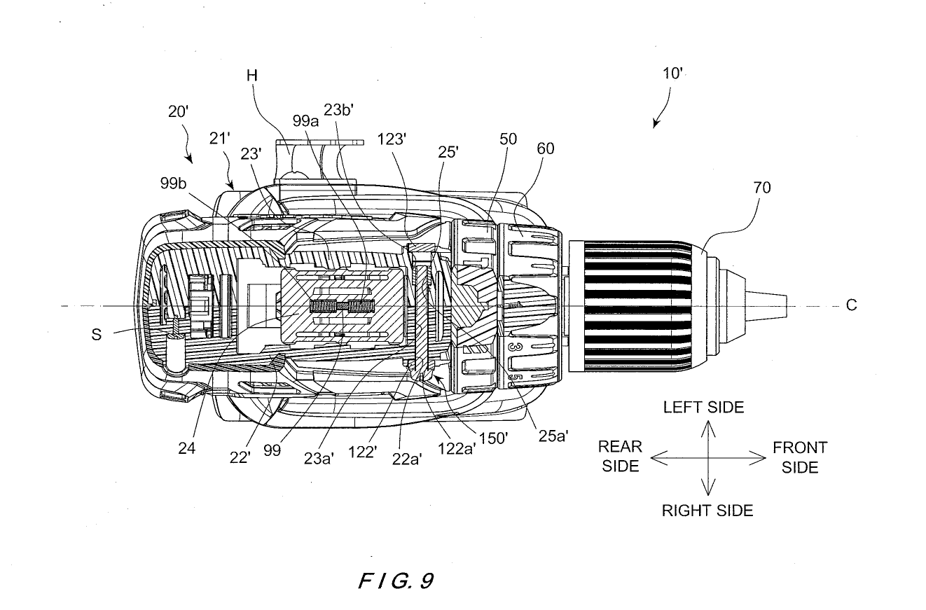

When the auxiliary handle member 100′ is coupled to the main body portion 20′ of the power tool 10′, the auxiliary handle member 100′ is positioned with respect to the main body portion 20′ of the power tool 10′ so that the upper flat surface 124a and the lower tapered surface 124b of the tapered projection 124 of the attachment part 123′ of the bracket 120′ respectively engage the upper flat surface 23d and the lower tapered surface 23e of the left housing cover 23′. Then, the aperture 122a′ of the attachment part 122′ of the bracket member 120′ are coaxially aligned with the through hole 21a′ of the outer housing cover 21′. More specifically, as shown in FIGS. 7 and 9, the aperture 122a′ of the attachment part 122′ is coaxially aligned with the through hole 22a′ of the right housing cover 22′. Then, the shaft 151′ of the screw 150′ is inserted from the aperture 122a′ of the attachment part 122′ of the bracket member 120′, and pass through the through hole 22a′ of the right housing cover 22′ and the through hole 23a′ of the left housing cover 23′. The screw 150′ is tightened so that the male thread formed on the shaft 151′ of the screws 150′ threadedly engages with the female thread in the female thread section 25a′ of the nut member 25′ as shown in FIGS. 7 and 9. Accordingly, the bracket member 120′ of the auxiliary handle member 100′ is fixedly coupled to the main body portion 20′ of the power tool 10′ by the nut member 25′ and the screw 150′ as shown in FIGS. 6 to 9. Therefore, the screw 150′ constitutes a male thread part of the auxiliary handle member 100′ when the auxiliary handle member 100′ is attached to the power tool 10′. At the same time, the nut member 25′ and the screw 150′ also serve as a fixing member that fixedly couples the right housing cover 22′ and the left housing cover 23′ at one of the prescribed fixing positions.

On the other hand, when power tool 10′ is used without the auxiliary handle member 100′ being attached thereto, the screw 150′ is used to fixedly couple the right housing cover 22′ and the left housing cover 23′. In such a case, the shaft 151′ of the screw 150′ is directly inserted through the through hole 22a′ of the right housing cover 22′ and the through hole 23a′ of the left housing cover 23′. The screw 150′ is tightened so that the male thread formed on the shaft 151′ of the screw 150′ threadedly engages with the female thread in the female thread section 25a′ of the nut member 25′. Therefore, the right housing cover 22′ and the left housing cover 23′ are fixed together by the nut member 25′ and the screw 150′ at one of the prescribed fixing positions while the screws S are used to fixedly couple the right housing cover 22′ and the left housing cover 23′ together at the rest of the prescribed fixing positions.

Accordingly, with the structure of the power tool 10′ according to the second embodiment, the screw 150′ and the nut member 25′ are used for fixing the bracket member 120′ of the auxiliary handle member 100′ to the main body portion 20′ as they simultaneously fix the right housing cover 22′ and the left housing cover 23′ together when the auxiliary handle member 100′ is used with the power tool 10′. On the other hand, when the auxiliary handle member 100′ is not used with the power tool 10′, the screw 150′ and the nut member 25′ are used for fixing the right housing cover 22′ and the left housing cover 23′ together. Moreover, the nut member 25′ is disposed at one of the prescribed fixing positions at which the right housing cover 22′ and the left housing cover 23′ are fixed together. Therefore, with the power tool 10′ according to the second embodiment, it is not necessary to provide an extra space in the main body portion 20′ for placing a nut member that is used only when the power tool accessory member is attached to the power tool 10′. Accordingly, with the structure of the power tool 10′ in the second embodiment, a space inside the main body portion 20′ can be efficiently used, thereby preventing the overall size of the main body portion 20′ of the power tool 10′ from increasing.

### Third Embodiment

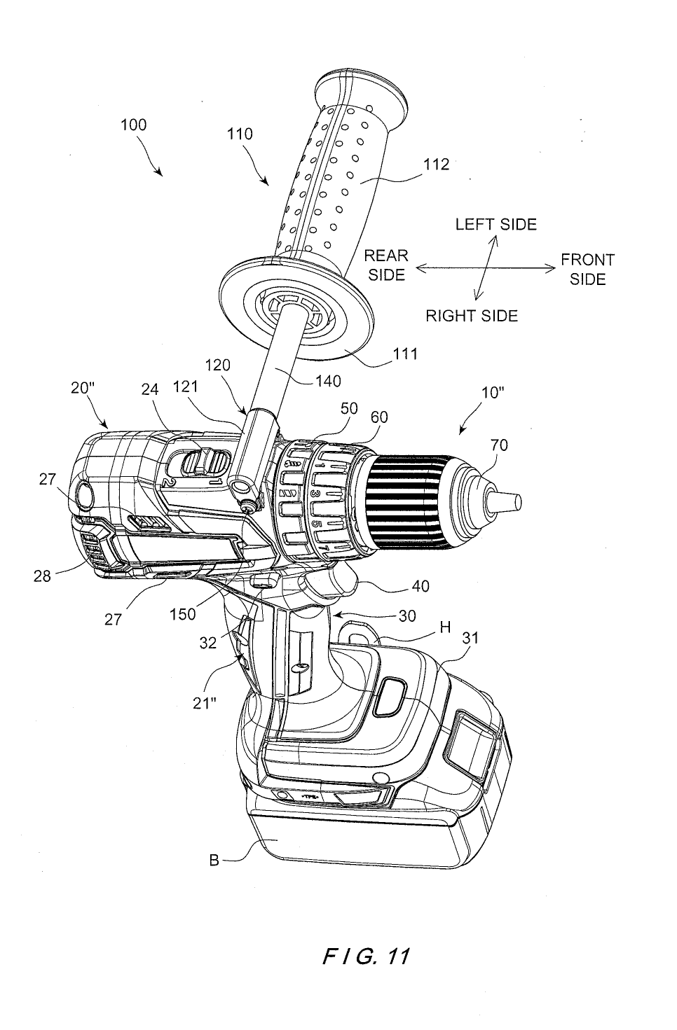

Referring now to FIGS. 11 to 15, a power tool 10″ with the auxiliary handle member 100 in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity. The parts of the third embodiment that differ from the parts of the first embodiment will be indicated with a double prime (″).

The power tool 10″ of the third embodiment differs from the power tool 10 of the first embodiment in that a nut member 25″ is supported by a front gear case 91″ of a gear assembly 90″ in the third embodiment. The structure of the auxiliary handle member 100 of the third embodiment is identical to the structure of the auxiliary handle member 100 explained in the first embodiment.

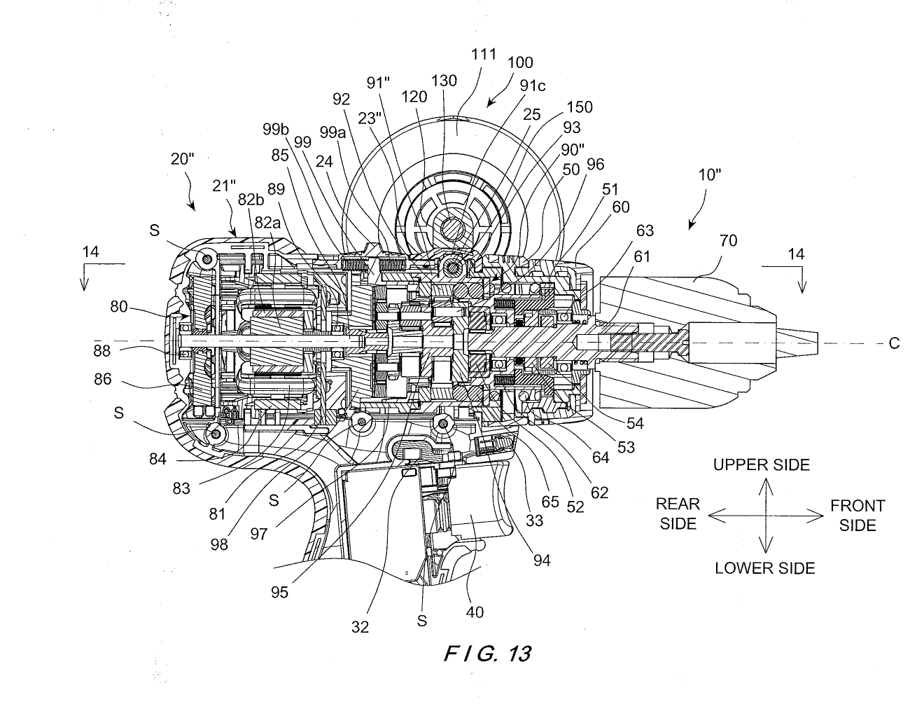

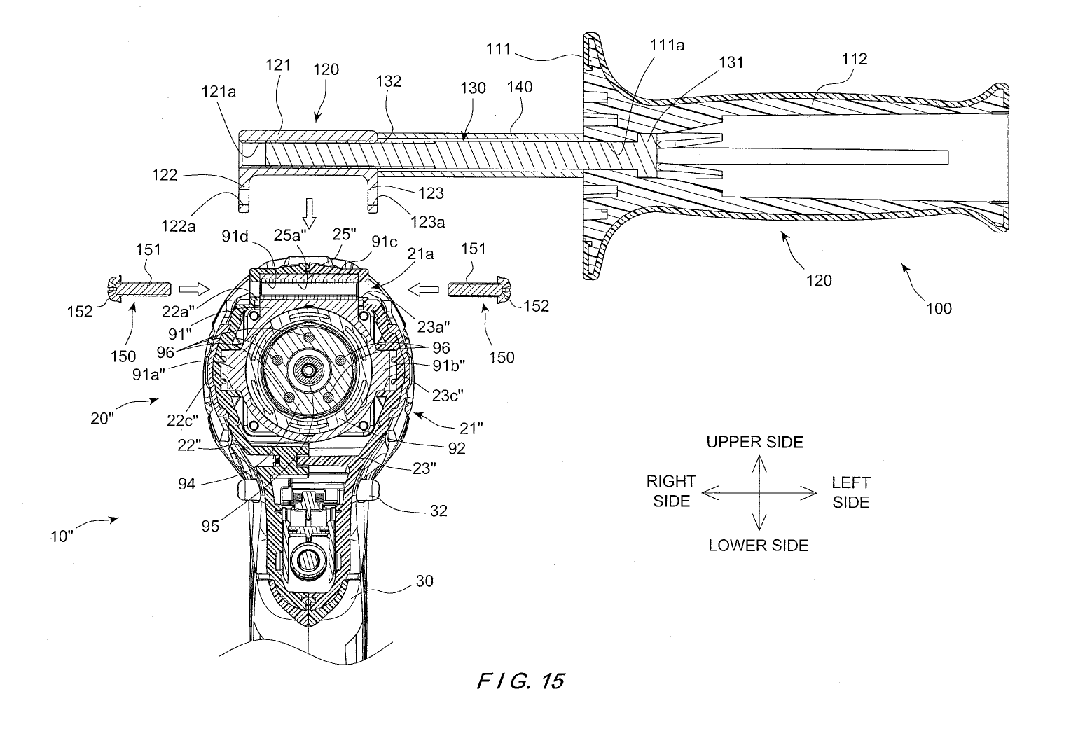

More specifically, in the third embodiment, the front gear case 91″ includes a bulged portion 91c that bulges out upwardly as shown in FIGS. 13 and 15. The bulged portion 91c of the front gear case 91″ includes a through hole 91d having a longitudinal axis extending in a transverse direction perpendicular to the longitudinal center axis C of the main body portion 20″. More specifically, the bulged portion 91c of the front gear case 91″ defines a generally polygonal inner contour constituting the through hole 91d in a cross section taken along a plane perpendicular to the longitudinal axis of the through hole 91d. More specifically, in this embodiment, the bulged portion 91c defines a generally rectangular inner contour constituting the through hole 91d as shown in FIG. 13.

The nut member 25″ (one example of a female thread part) having an elongated tubular body is disposed in the through hole 91d formed in the bulged portion 91c of the front gear case 91″. More specifically, the nut member 25″ is disposed at one of the prescribed fixing positions in the main body portion 20″ at which the right housing cover 22″ and the left housing cover 23″ are fixed together by the screws S and the screws 150. As shown in FIG. 13, these prescribed fixing positions are spaced apart from each other. The nut member 25″ is coaxially arranged with in the through hole 91d so that a longitudinal axis of the nut member 25″ extends in a transverse direction perpendicular to the longitudinal center axis C of the main body portion 20″. An inner circumference surface of the nut member 25″ includes a female thread section 25a″ provided with a female thread.

The nut member 25″ has a generally polygonal outer contour in a cross section taken along a plane perpendicular to the longitudinal axis of the nut member 25″. More specifically, in this embodiment, the nut member 25″ has a generally rectangular outer contour as shown in FIG. 13. The inner contour of the bulged portion 91c of the front gear case 91″ defining the through hole 91d matches the generally rectangular outer contour of the nut member 25″. Therefore, the nut member 25″ is non-rotatably fitted in the through hole 91d formed in the front gear case 91″ as shown in FIG. 13.

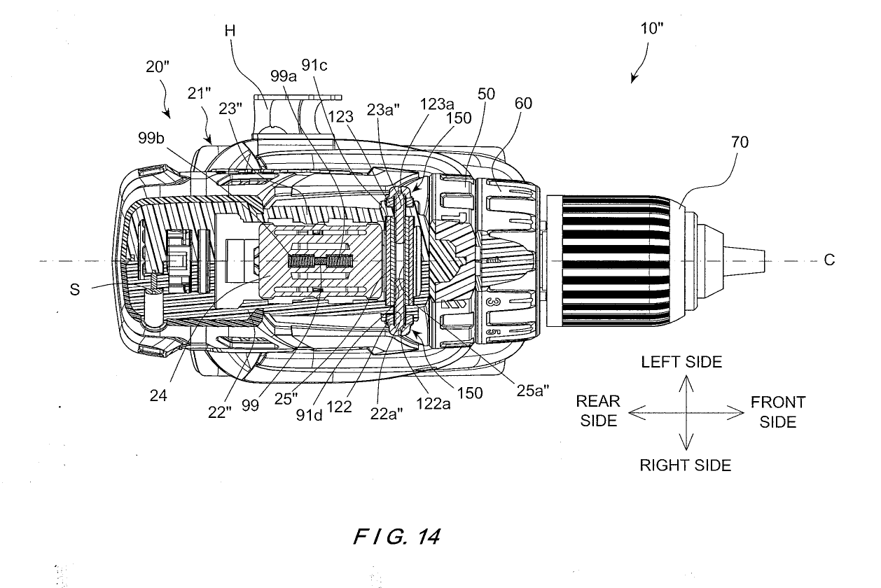

The right housing cover 22″ defines an aperture 22a″ coaxially arranged with respect to the through hole 91d formed in the bulged portion 91c of the front gear case 91″. Likewise, the left housing cover 23″ defines an aperture 23a″ coaxially arranged with respect to the through hole 91d formed in the bulged portion 91c of the front gear case 91″. A maximum inner diameter of the aperture 22a″ of the right housing cover 22″ and a maximum inner diameter of the aperture 23a″ of the left housing cover 23″ are smaller than a minimum outer diameter of the nut member 25″ as shown in FIGS. 14 and 15. Therefore, movement of the nut member 25″ with respect to the outer housing cover 21″ in the transverse direction is restricted by the right housing cover 22″ and the left housing cover 23″. On the other hand, the maximum inner diameter of the aperture 22a″ of the right housing cover 22″ and the maximum inner diameter of the aperture 23a″ of the left housing cover 23″ are larger than a maximum inner diameter of the nut member 25″ (i.e., the major diameter of the female thread in the female thread section 25a″). Therefore, the aperture 22a″ of the right housing cover 22″ and the aperture 23a″ of the left housing cover 23″ define a pair of access openings respectively formed on each side of the outer surface of the main body portion 20″ through which the female thread in the female thread section 25a″ is accessible from an outside of the main body portion 20″.

Similarly to the first and second embodiments, as shown in FIG. 15, the right housing cover 22″ includes a concave portion 22c″ to which a right side convex portion 91a″ of the front gear case 91″ is inserted. Likewise, the left housing cover 23″ includes a concave portion 23c″ to which a left side convex portion 91b″ of the front gear case 91″ is inserted. Therefore, the front gear case 91″ is fixedly secured between the right housing cover 22″ and the left housing cover 23″, and rotation of the front gear case 91″ with respect to the right hosing cover 22″ and the left housing cover 23″ is prevented.

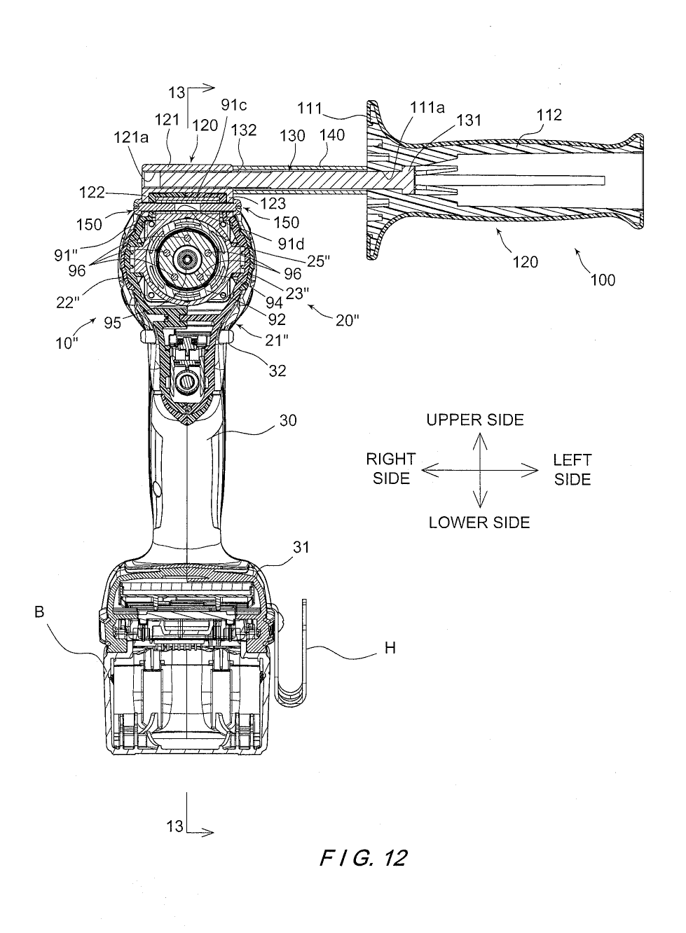

When the auxiliary handle member 100 is coupled to the main body portion 20″ of the power tool 10″, the auxiliary handle member 100 is positioned with respect to the main body portion 20″ of the power tool 10″ so that the aperture 122a of the attachment part 122 of the bracket member 120 is coaxially aligned with the aperture 22a″ of the right housing cover 22″ and the aperture 123a of the attachment part 123 is coaxially aligned with the aperture 23a″ of the left housing cover 23″. Then, the shafts 151 of the screws 150 are inserted from the apertures 122a and 123a of the attachment parts 122 and 123 of the bracket member 120, and pass through the apertures 22a″ and 23a″ of the right housing cover 22″ and the left housing cover 23″, respectively. The screws 150 are tightened so that the male threads formed on the shafts 151 of the screws 150 threadedly engage with the female thread in the female thread section 25a″ of the nut member 25″ from each transverse side of the nut member 25″ as shown in FIGS. 12 and 14. Accordingly, the bracket member 120 of the auxiliary handle member 100 is fixedly coupled to the main body portion 20″ of the power tool 10″ by the nut member 25″ and the screws 150 as shown in FIGS. 11 to 14. Therefore, the screws 150 constitute a male thread part of the auxiliary handle member 100 when the auxiliary handle member 100 is attached to the power tool 10″. At the same time, the nut member 25″ and the screws 150 also serve as a fixing member that fixedly couples the right housing cover 22″ and the left housing cover 23″ at one of the prescribed fixing positions.

On the other hand, when power tool 10″ is used without the auxiliary handle member 100 being attached thereto, the screws 150 are used to fixedly couple the right housing cover 22″ and the left housing cover 23″. In such a case, the shafts 151 of the screws 150 are directly inserted through the apertures 22a″ and 23a″ of the right housing cover 22″ and the left housing cover 23″, respectively. The screws 150 are tightened so that the male threads formed on the shafts 151 of each of the screws 150 threadedly engage with the female threads in the female thread section 25a″ of the nut member 25″ from each transverse side of the nut member 25″. Therefore, the right housing cover 22″ and the left housing cover 23″ are fixed together by the nut member 25″ and the screws 150 at one of the prescribed fixing positions while the screws S are used to fixedly couple the right housing cover 22″ and the left housing cover 23″ together at the rest of the prescribed fixing positions.

Accordingly, with the structure of the power tool 10″ according to the second embodiment, the screws 150 and the nut member 25″ are used for fixing the bracket member 120 of the auxiliary handle member 100 to the main body portion 20″ as they simultaneously fix the right housing cover 22″ and the left housing cover 23″ together when the auxiliary handle member 100 is used with the power tool 10″. On the other hand, when the auxiliary handle member 100 is not used with the power tool 10″, the screw 150 and the nut member 25″ are used for fixing the right housing cover 22″ and the left housing cover 23″ together. Moreover, the nut member 25″ is disposed at one of the prescribed fixing positions at which the right housing cover 22″ and the left housing cover 23″ are fixed together. Therefore, with the power tool 10″ according to the second embodiment, it is not necessary to provide an extra space in the main body portion 20″ for placing a nut member that is used only when the power tool accessory member is attached to the power tool 10″. Accordingly, with the structure of the power tool 10″ in the second embodiment, a space inside the main body portion 20″ can be efficiently used, thereby preventing the overall size of the main body portion 20″ of the power tool 10″ from increasing.

Although in the first to third embodiments the auxiliary handle member 100 or 100′ is explained as an example of the power tool accessory member, the power tool accessory member is not limited to an auxiliary handle member. For example, the power tool accessory member may be any kind of accessory member used with the power tool, such as an external lighting unit, a hook member, etc. When a power tool accessory member other than the auxiliary handle member 100 or 100′ is used with the power tool 10, 10′ or 10″, the power tool accessory member is preferably provided with a bracket member having the attachment parts 122 and 123, or 122′ and 123′ as explained above. Therefore, the power tool accessory member can be fixedly coupled to the power tool as explained above.

The first to third embodiments show an example in which the auxiliary handle member 100 or 100′ is positioned with respect to the power tool 10, 10′ or 10″ so that the auxiliary grip portion 110 is disposed on the left side of the main body portion 20, 20′ or 20″ to generally form a right angle with respect to the grip portion 30 of the power tool 10, 10′ or 10″ when viewed along the center axis C. However, it will be apparent to those skilled in the art from this disclosure that the auxiliary handle member 100 or 100′ can be positioned with respect to the power tool 10, 10′ or 10″ so that the auxiliary grip portion 110 is disposed on the right side of the main body portion 20, 20′ or 20″ depending on the user's preference. In such a case, the threaded rod member 130 coupled to the auxiliary grip portion 110 is inserted in the female thread section 121a or 121a′ of the bracket member 120 or 120′ from the right side of the bracket member 120 or 120′.

Although the power tool 10, 10′ or 10″ is illustrated as a hammer driver drill in the first to third embodiments, the power tool 10, 10′ or 10″ according to the first to third embodiments is applicable to various types of power tools, such as a driver drill, an impact driver, an impact wrench, etc. Moreover, the structure for mounting the power tool accessory member according to the first to third embodiments is also applicable to a power tool having a housing that does not have a generally pistol-like overall shape. For example, the structure for mounting the power tool accessory member may be applied to a power tool having a generally linear-shape housing such as an angle drill or the like.

Although the cordless power tool 10, 10′ or 10″ is illustrated as an example of a power tool in the first to third embodiments, the power tool is not limited to a cordless tool coupled to a rechargeable battery. It will be apparent to those skilled in the art from this disclosure that the power tool assembly according to any of the first to third embodiments is applicable to a corded power tool with a power cable.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “front”, “rear”, “above”, “downward”, “vertical”, “horizontal”, “below” and “transverse” as well as any other similar directional terms refer to those directions of a power tool when the power tool is oriented as shown in FIG. 1. Accordingly, these terms, as utilized to describe the present invention should be interpreted relative to the power tool. The terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A power tool comprising:
a motor unit;
a main body portion accommodating the motor unit therein;
a grip portion extending from the main body portion; and
a female thread part retained to the main body portion, the female thread part including a female thread configured and arranged to engage with a male thread of a male thread part of a power tool accessory member.

2. The power tool according to claim 1, further comprising
the power tool accessory member including the male thread part engaging with the female thread part.

3. The power tool according to claim 2, wherein
the power tool accessory member is an auxiliary handle member including an auxiliary grip portion.

4. The power tool according to claim 3, wherein
the auxiliary handle member includes a bracket fixedly coupled to the main body portion by engagement between the male thread part and the female thread part, and
the auxiliary grip portion is fixedly coupled to the bracket.

5. The power tool according to claim 1, wherein
the female thread part includes a generally tubular body with the female thread formed on an inner circumferential surface thereof.

6. The power tool according to claim 5, wherein
the female thread part is arranged inside the main body portion so that a center axis of the generally tubular body extends in a direction substantially perpendicular to a longitudinal axis of the main body portion.

7. The power tool according to claim 1, wherein
the main body part defines a pair of access openings respectively formed on each side of the outer surface of the main body portion, and
the female thread part is disposed between the access openings.

8. The power tool according to claim 7, wherein
the female thread part includes a generally tubular body with the female thread formed on an inner circumferential surface thereof, and both axial ends of the tubular body of the female thread part are open so that the female thread is accessible through both of the access openings.

9. The power tool according to claim 5, wherein
the tubular body of the female thread part has a generally polygonal cross-sectional outer contour as taken along a plane perpendicular to a center axis of the tubular body.

10. The power tool according to claim 1, wherein
the female thread part is press fitted in the main body portion.

11. The power tool according to claim 1, wherein
the main body portion includes a first side body section and a second side body section, and
the female thread part is in contact with at least the second side body section.

12. The power tool according to claim 11, wherein
the female thread part is in contact with only the second side body section.

13. The power tool according to claim 11, wherein
the female thread part is in contact with both of the first side body section and the second side body section.

14. The power tool according to claim 13, wherein
the female thread part is press fitted in the first side body section and the second side body section.

15. The power tool according to claim 1, further comprising
a gear case disposed inside the main body portion,
the female thread part being retained in the gear case.
